(19) United States
(12) Patent Application Publication
(10) Pub. No.: US 2021/0295586 A1
(43) Pub. Date: Sep. 23, 2021

(54) METHODS AND APPARATUS FOR DECOUPLED SHADING TEXTURE RENDERING

(71) Applicant: Samsung Electronics Co., Ltd., Suwon-si (KR)

(72) Inventor: Derek J. LENTZ, Reno, NV (US)

(21) Appl. No.: 16/864,137

(22) Filed: Apr. 30, 2020

Related U.S. Application Data
(60) Provisional application No. 62/992,898, filed on Mar. 20, 2020.

(51) Int. Cl. G06T 15/00; G06T 1/20; G06T 1/60

(52) U.S. Cl. CPC G06T 15/005; G06T 1/60; G06T 1/20

(57) ABSTRACT

A method for rendering an image in a graphics processing system may include calculating texture coverage data for an image during an image coverage pass using a rendering pipeline, generating rendered texture data during a texture rendering pass in texture space based on the texture coverage data using one or more hardware resources of the rendering pipeline, and rendering the image based on the rendered texture data using the rendering pipeline. A graphics processing system may include a rendering pipeline configured to support decoupled shading, the pipeline may include a data buffer configured to receive texture coverage data for an image, and a rasterization unit configured to read the texture coverage data from the data buffer and use the texture coverage data to limit rasterization coverage during a texture rendering pass for the image.

### CROSS-REFERENCE TO RELATED APPLICATION

This application claims priority to, and the benefit of, U.S. Provisional Patent Application Ser. No. 62/992,898 titled “Decoupled Shading Texture Rendering” filed Mar. 20, 2020 which is incorporated by reference.

### TECHNICAL AREA

This disclosure relates generally to graphics processing, and specifically to methods and apparatus for rendering textures in a decoupled shading process.

### BACKGROUND

A graphics processing unit (GPU) may use shaders for real-time rendering of images. Shading work may involve large amounts of computations and/or power consumption. To improve performance and/or efficiency, rendering techniques may attempt to reduce shading work by identifying objects or surfaces that may not be visible in a final image, and then shading only those objects or surfaces that are visible. In a decoupled shading technique, visibility work may be performed separately from shading work.

### SUMMARY

A method for rendering an image in a graphics processing system may include calculating texture coverage data for an image during an image coverage pass using a rendering pipeline, generating rendered texture data during a texture rendering pass in texture space based on the texture coverage data using one or more hardware resources of the rendering pipeline, and rendering the image based on the rendered texture data using the rendering pipeline. The method may further comprise storing at least a portion of the texture coverage data in a hardware resource of the rendering pipeline. The texture coverage data may be stored in a color processing unit. The texture coverage data may be stored in a tile buffer. The texture coverage data may be stored in a multiple render target (MRT). The texture coverage data stored in the MRT may include multiple coverages. The texture coverage data may be calculated for two or more textures. The two textures may be independently addressed. At least a portion of the texture coverage data may include common location data for the two textures. The texture coverage data may be used to limit surviving rasterization coverage during the texture rendering pass.

A graphics processing system may include a rendering pipeline configured to support decoupled shading, the pipeline may include a data buffer configured to receive texture coverage data for an image, and a rasterization unit configured to read the texture coverage data from the data buffer and use the texture coverage data to limit rasterization coverage during a texture rendering pass for the image. The rasterization unit may be configured to use two or more sets of texture coverage data. The rasterization unit may be configured to use the two sets of texture coverage data to limit coverage to add only additional coverage required by a later frame. The rasterization unit may be one of two or more rasterization units arranged such that rendering is partitioned among the two rasterization units. The data buffer may be at least partially contained in a color processing unit. The data buffer may be at least partially contained in one or more tile buffer units. The rendering pipeline may be configured for tile-based rendering.

A graphics processing system may include a rendering pipeline configured to support decoupled shading, the pipeline may include a texture unit configured to receive a coverage query from a shader during an image coverage pass, compute texture coverage data for an image in response to the coverage query, and return the texture coverage data to the shader, and a data buffer configured to receive the texture coverage data from the shader. The shader may include a pixel shader. The data buffer may be at least partially contained in a color processing unit.

### BRIEF DESCRIPTION OF THE DRAWINGS

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims. To prevent the drawing from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates a pipeline pass diagram for an embodiment of a method for decoupled shading using a rendering pipeline according to this disclosure.

FIG. 2 illustrates a pipeline pass diagram for an example embodiment of a method for decoupled shading using a rendering pipeline according to this disclosure.

FIG. 3 illustrates an embodiment of a texture coverage pipeline according to this disclosure.

FIG. 4 illustrates embodiments of pipeline hardware components that may be used for a rendering pipeline that may support decoupled shading according to this disclosure.

FIG. 5 illustrates an example embodiment of a bitmap rasterization decoding operation for a texture culling operation according to this disclosure.

FIG. 6 illustrates an embodiment of an imaging device according to this disclosure.

### DETAILED DESCRIPTION

Some embodiments of a GPU according to this disclosure may use decoupled shading which separates shading operations from final image rendering. Decoupled shading may be implemented, for example, by performing shading in texture space which may be separate from screen space. The use of separate texture and screen spaces may improve graphics quality, efficiency and/or speed by enabling texture rendering and final image rendering to be performed in separate coordinate systems, at different resolutions, on different time scales, and/or the like. For example, some effects like motion blur or defocus blur may be computationally intensive and therefore relatively expensive and/or slow to calculate. However, these effects may not need to be rendered at full screen resolution. By rendering data for these effects at a lower resolution in texture space, it may reduce the computational workload compared to rendering them at full resolution in screen space. As a further example, some information such as light maps may not change between frames. The use of decoupled shading may reduce shading workload by enabling calculations for such information to be reused by multiple frames.

To further improve performance and/or efficiency, some rendering techniques according to this disclosure may reduce rendering (shading) work by eliminating computations on parts of a texture that are not visible in the final image. This may be accomplished, for example, by creating a coverage data structure such as a bitmap that maps the coverage of visible texels, and only rendering texture for covered texels.

To implement a decoupled shading technique, some embodiments of a GPU according to this disclosure may run a screen space pass using a pixel shader to determine which texels may need to be rendered in texture space. A compute shader may then render textures using a coverage map created by the pixel shader. In some embodiments, the use of a compute shader for texture rendering as described above may involve expensive, time consuming, and/or inefficient data movement and/or manipulation. For example, the pixel shader may use expensive and/or inefficient atomic operations to record and accumulate coverage. The coverage may be stored as a coverage map in system memory using store operations that may involve special coalescing hardware which may also be inefficient. The compute shader may then read the coverage map back from system memory. The compute shader may also read primitive and vertex information from system memory, which may involve large amounts of cache bandwidth to access vertex arrays, index arrays, attribute arrays, and/or state information to map vertex attributes to pixel shader attributes. Compute shader threads may also interpolate vertex attributes from structures read from system memory. The compute shader may further implement software rasterization for texture rendering. Any or all of these operations may involve large amounts of shader computation cycles, memory access, power consumption, and/or the like.

In some embodiments, a GPU according to this disclosure may include a rendering pipeline that may include features such as specialized hardware resources to perform functions such as rasterization, attribute data fetch, and/or interpolation, as well as pixel shaders, vertex shaders, geometry shaders, and/or the like. In some embodiments according to this disclosure, one or more texture coverage and/or rendering operations such as those described above may be implemented, at least in part, using rendering pipeline hardware. Depending on the implementation details, this may improve performance and/or efficiency by enabling texture coverage and/or texture rendering algorithms to take advantage of the efficiency and/or performance that may be provided by specialized pipeline hardware and/or other pipeline features. The multi-pass nature of the texture coverage and/or rendering algorithms may fit well into a GPU pipeline architecture. Thus, in some embodiments, an existing pipeline design may be readily and/or efficiently adapted to implement one or more texture coverage and/or rendering operations according to this disclosure. Moreover, coverage and/or rendering output data may be stored in hardware at various locations within the pipeline, thereby taking advantage of specialized hardware designed for rapid data movement between pipeline elements.

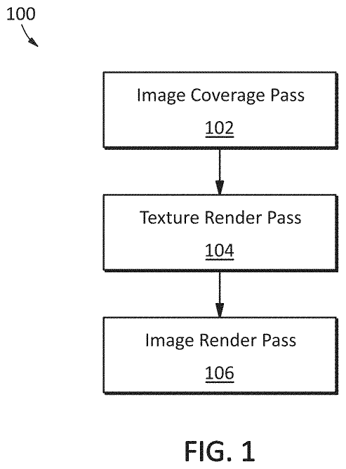

FIG. 1 illustrates a pipeline pass diagram for an embodiment of a method for decoupled shading using a rendering pipeline according to this disclosure. The method 100 illustrated in FIG. 1 may include an image coverage pass 102 in which coverage may be computed for texels and/or groups of texels that may be rendered in a final image. The coverage may be computed, for example, using a pixel shader that may generate coverage data and store it in a bitmap or other coverage data structure. The data structure may be saved, for example, at least partially in a data buffer within pipeline hardware such as a color processing unit and/or a tile buffer unit. Alternatively, the data structure may be saved in system memory or other suitable location. Coverage may be generated for multiple textures whether independently addressed or not. Multiple data structures may be used for multiple textures, or multiple textures may be combined in a data structure, for example, if they are located at the same locations (e.g., u, v coordinates) in texel space.

The method 100 may also include a texture render pass 104 in which one or more textures may be rendered, i.e., shaded, in texture space based on some or all of the coverage data generated in the image coverage pass. That is, coverage data may be used to limit surviving rasterization coverage during texture rendering. For example, the coverage data may be used to qualify hardware rasterization so that texels and/or blocks of texels may be rendered if (e.g., only if) they may be included in a final image.

In some embodiments, the pipeline, e.g., rasterization hardware, may implement multiple sets of coverage. For example, coverage may be accumulated from multiple hardware rendering structures, e.g., when rendering is partitioned among multiple hardware rendering units. In such an implementation, texture coverage may generally be independent of final image locations. As another example, one or more coverage data structures such as bitmasks may be retrieved from a prior rendering operation to remove coverage that has previously been rendered (e.g., in a prior frame) when performing a new rendering operation (e.g., for a new frame) so that texels may be rendered if (e.g., only if) they are covered in the new frame but not the prior frame.

The method 100 may also include an image render pass 106 in which a final image may be rendered based at least in part on a rendered texture image generated by the texture render pass 104 in which visible blocks of texels may have been shaded during texture rendering. The image render pass 106 may be implemented for example, with a pixel shader configured to read rendered textures and write out to final render targets. In some embodiments, and depending on the implementation details such as motion or defocus blur, the image render pass 106 may be used in conjunction with one or more other techniques such as early quad discard and/or a culling during binning function.

The embodiment illustrated in FIG. 1 may be implemented with any suitable type of graphics rendering pipeline including pipelines having a tile-based deferred rendering (TBDR) architecture, an immediate mode rendering (IMR) architecture, an IMR architecture that may emulate tile based operations by performing some binning to tiles, and/or any other configuration or combination thereof.

The operations and/or components described with respect to the embodiment illustrated in FIG. 1, as well as any other embodiments described herein, are example operations and/or components. In some embodiments, some operations and/or components may be omitted and/or other operations and/or components may be included. Moreover, in some embodiments, the temporal and/or spatial order of the operations and/or components may be varied.

Some example embodiments of systems, processes, methods, and/or the like illustrating some possible implementation details according to this disclosure are described below. These examples are provided for purposes of illustrating the principles of this disclosure, but the principles are not limited to these embodiments, implementation details, and/or the like.

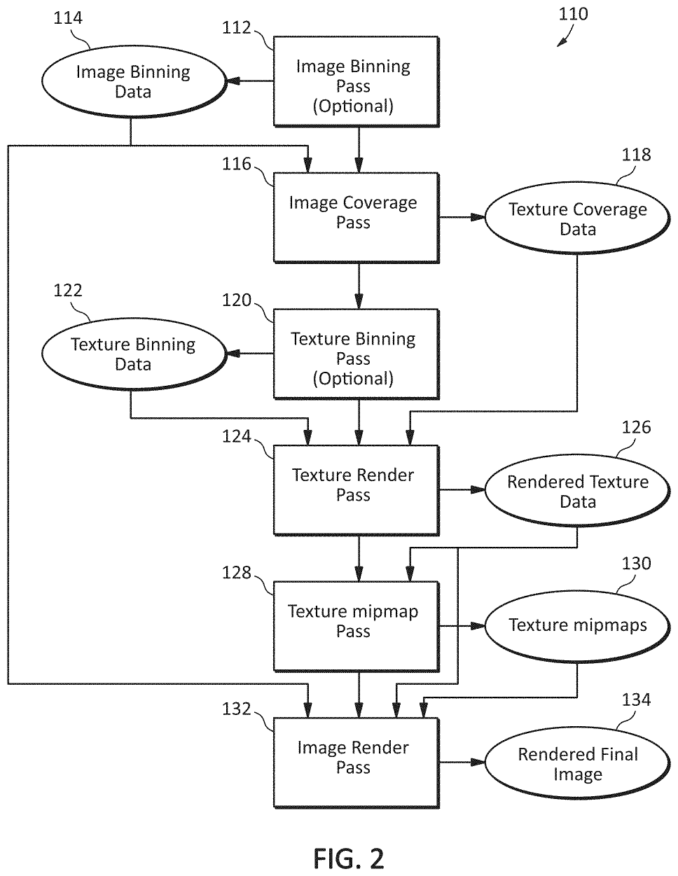

FIG. 2 illustrates a pipeline pass diagram for an example embodiment of a method for decoupled shading using a rendering pipeline according to this disclosure. The embodiment 110 illustrated in FIG. 2 may illustrate some details relating to tile-based implementations, but the principles may also be applied to other types of systems such as IMR systems. The embodiment 110 may be implemented, for example, with a rendering pipeline that may include any number of hardware features such as texture units, color processing units, tile buffer units and/or other specialized hardware to perform functions such as rasterization, attribute data fetch, and/or interpolation. The pipeline may also include any number of software-driven features such as pixel shaders, vertex shaders, geometry shaders, and/or the like which may be specialized and/or tightly integrated into the hardware aspects of the pipeline, and thus, depending on the implementation details, may provide improved performance and/or efficiency compared, for example, to a compute shader.

In embodiments that may include tiling, the method 110 may include an optional rendered image binning pass 112 which may generate image binning data 114 for use by image coverage pass 116 and/or image render pass 132. In some embodiments, a geometry shader may be used, for example, for motion blur and/or depth-of-field (e.g., defocus blur) rasterization (which may be conservative) and decomposition into one or more sets of time-dependent primitives such as triangles. This may be performed, for example, in any or all of the binning passes and/or the two render passes. Image binning and/or binning depth data may be generated based on primitives including time-dependent primitives. In some embodiments, and depending on the implementation of effects such as blurs, a binning depth culling function may be implemented.

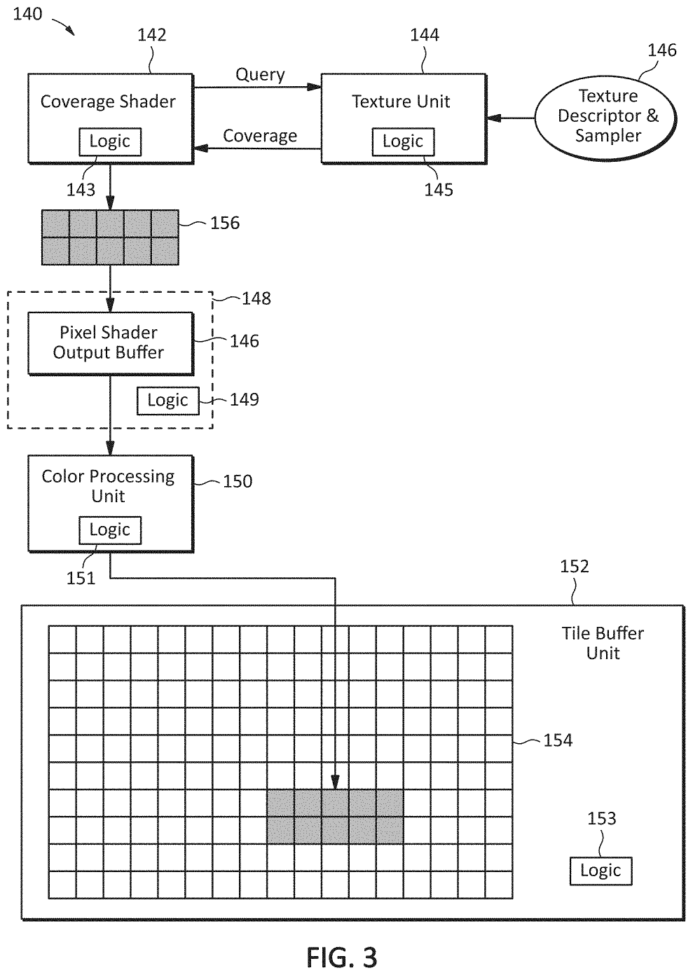

Referring again to FIG. 2, an image coverage pass 116 may generate texture coverage data 118 for use during a texture render pass 124. The image coverage pass 116 may be implemented, for example, with a pixel shader (which may be implemented as one or more pixel shaders) that may include logic configured to implement a texture access function to request texture coverage (rather than texture data) from a texture unit (which may be implemented as one or more texture units), as illustrated below with respect to FIG. 3. This may be accomplished, for example, by issuing one or more texture operations to the texture unit, thereby instructing it to compute texel locations (coverage) and return this texture coverage data to the pixel shader. In some embodiments only a subset of the image may be rendered during the image coverage pass 116. For example, only objects that access partially rendered textures may need to be rendered, Thus, in some implementations, only draw calls that render using partially rendered textures may be executed. In some embodiments, some or all of the image coverage pass 116 may be implemented in hardware (e.g., a modified texture unit as described below), software (e.g., pixel shader software), or any combination thereof.

Based on the texture coverage data from the texture unit, the image coverage pass 116 may generate a coverage data structure or “coverage structure” that may specify visible texels and/or blocks of texels that may be rendered in a final image. In some embodiments, the pixel shader may create bounding boxes of coverage or some other encoding of coverage information. The coverage structure may be used by the subsequent texture render pass 124 to limit texture rendering to visible texels. In some implementations, a hierarchical and/or compressed data structure may be used for the texture coverage, for example, a compressed bitmap. Although an actual image may not be rendered during the image coverage pass 116, in some embodiments, a depth buffer may be rendered and may be reused, for example, by the image rendering pass 132.

In some embodiments, coverage may be detected and generated for multiple textures, and one or more texture coverage structures may be generated if multiple textures are to be rendered in the final image. For example, a coverage structure may be used for each texture if it has a unique texture location (u, v coordinates in texture space) and/or has different texture coverage for any reason (e.g. because of using a different texture filter), unless a superset may be used efficiently. In some embodiments, textures having the same addressing may use the same coverage information, whereas textures with different coverage may be separated.

In implementations where multiple graphics cores may be used to generate coverage structures, the masks created by the different cores may be bitwise OR'ed for use in the final image render pass 132. Such an OR operation may generate coverage that may be the union of coverage from the different graphics cores. Alternatively, masks created by the different graphics cores may be stored separately and OR'ed during a subsequent texture render pass 124. In some embodiments, coverage data may be bitwise OR'ed with previously written data.

A pixel shader used to implement the image coverage pass 116 may also include logic configured to write out the texture coverage data 118 for use during the subsequent texture render pass 124. For example, the texture coverage data may be written to a color processing unit as illustrated below with respect to FIG. 3. In some embodiments, this data may be written to the color processing unit as if it is color data. A color processing unit may be implemented, for example, as modified color blending hardware. The coverage data may be accumulated and/or stored at any level of coarse or fine granularity. For example, a texture coverage bitmap structure may be stored at one bit per one texel, one bit per 4×4 quad of texels, one bit per 8×8 block of texels, etc.

In some embodiments, a color processing unit (e.g., color blending hardware) may accumulate texture coverage data in one or more multiple render targets (MRTs), for example, in one or more tile buffer units as illustrated in FIG. 3, in one or more dedicated render targets in system memory, and/or in any other suitable location. In some implementations, one or more existing or standard MRT structures may be used to hold texture coverage data. Alternatively, or additionally, coverage data for multiple textures may be packed into one or more MRT structures, for example, using offsets to separate and/or index the textures. In some other implementations, coverage data for multiple textures may be handled independently.

In some embodiments, existing color processing hardware may be readily modified, for example, with the addition or modification of some internal logic, to recognize texture coverage output data from a pixel shader and store it in an external rasterization coverage format. In some embodiments, color processing hardware may also be configured to merge input texture coverage data with stored texture-coverage (e.g. using a bit-wise OR) to accumulate texture coverage from various input primitives.

In some embodiments, and depending on the implementation details, an image coverage pass according to this disclosure may improve performance and/or efficiency, for example, by avoiding atomic operations, by avoiding store operations that require special coalescing, by eliminating the need for software emulation of a frontend graphics pipeline (such as index and vertex fetch, vertex transformations, clipping and/or culling), and/or by using one or more hardware structures within a render pipeline such as a color processing unit and/or tile buffer unit to accumulate and/or store texture coverage data. These structures may be designed for fast and/or efficient data transfers between pipeline elements, and the texture coverage data structures may be implemented as compact structures (e.g., bitmaps). Moreover, depending on the implementation details, any number of the processes implemented in an image coverage pass according to this disclosure may be parallelized as well.

Referring again to FIG. 2, in embodiments that may include tiling, an optional texture image binning pass 120 may generate texture binning data 122 for use by texture render pass 124. In some embodiments, one texture image rendering pass may be implemented per rendered texture.

A texture render pass 124 may render (i.e., shade) texels in texture space using the textures that may be used in the final rendered image, while using the texel coverage data 118 from the image coverage pass 116 to prevent rendering of unused texels. For example, rasterization hardware in the rendering pipeline may include logic configured to read the texel coverage data 118 and use it as a coverage mask to prevent rendering of texels that may not be used by the image rendering pass 132. In some embodiments, the rasterization hardware may be implemented, for example, as part of a rasterization and depth testing unit. In some embodiments in which stochastic rasterization may be used, one or more pixel shaders may be configured to cast rays and compute texel locations in covered rendered textures.

In tile-based implementations, in which coverage data may be accessed through or saved in a tile buffer unit, the rasterization or tile buffer hardware may load texture coverage data associated with a texture map tile. Subsequently, rendering for that tile may commence. In other implementations, the rasterization hardware may load the texture coverage data from a color processing unit and/or any other location from which it may be stored. In some embodiments, a tile buffer unit and/or rasterization hardware may perform a bitwise OR of separate texture coverage masks created by the different graphics cores, for example, if they have not previously been OR'ed during the image coverage pass 116. This may ensure coverage from multiple graphics cores or subdivided image renderings may be merged to obtain complete coverage.

In some embodiments, incremental rendering may be used to add one or more texels for a new frame while reusing a texture generated by a previous frame or sequence of frames. For example, if a new frame reuses one or more rendered texels from a previous frame, an AND-NOT bitwise operation may be applied to the coverage data to prevent rendering of texels and/or texel blocks that may not need to be rendered again during the later frame and/or frame sequence. In other words, in some implementations, a texture render pass for a new frame or frames may only render texels that have been added to a new frame compared to the previous frame.

In some embodiments, and depending on the implementation details, a texture render pass according to this disclosure may improve performance and/or efficiency, for example, by reducing the amount of texture rendering work, by taking advantage of built-in pipeline hardware resources such as rasterizers, interpolators, and/or the like, as well as by taking advantage of efficient hardware infrastructure for moving data between components. Moreover, because texture rendering pixel shader computations may be relatively expensive in terms of time and/or power, any reduction of rendering work may have significant performance and/or power benefits.

Referring again to FIG. 2, during one or more texture mipmap passes 128, a set of texture mipmaps 130 may generated from each rendered texture image, for example, by down-sampling a rendered texture image. The texture mipmaps 130 may then be used during the final image render pass 132. In some implementations, down-sampling may be further optimized, for example, by recording level of detail (LOD) information in the coverage data structure or deriving it from the coverage data structure. In some implementations, mipmaps may also be incrementally added between frames, for example, just as full resolution texture may be added to it.

The final render pass 132 actually renders the final image 134 after the required blocks of texels have been shaded during texture rendering. The final render pass 132 may be implemented as a standard color pass using, for example, a regular pixel shader to repeat the image cover pass but using the rendered texture data 126 from one or more final render targets. Embodiments that implement tiling may use the image binning data 114.

In some embodiments, one or more coverage passes may be configured to generate conservative coverage, in which case work may then be reduced or minimized based on actual final image coverage, and the pipeline hardware may make use of this coverage to limit rendered texture work. In some embodiments, rendered texture dependencies may be addressed. For example, a first rendered texture is used to control addressing of a second rendered texture, coverage pass for the second rendered texture may be executed after the first rendered texture has been fully rendered so it may make use of rendered texture data for the first rendered texture.

In some embodiments, and depending on the implementation details, a decoupled texture shading process using a rendering pipeline as described above may provide any number of the following features and/or benefits. All or a portion of a proven-design rendering hardware pipeline, which may have optimized hardware, may be available for use during all or a portion of the process. The texture coverage calculation may be implemented for multiple independently addressed textures. Texture coverage may be accumulated across multiple final images, and thus, computations may only be performed for new texels, thus supporting texture reuse between frames or final images. Shading may be more efficiently performed in texture space. Motion blurred and/or defocus blurred objects may be rendered by integrating existing techniques into the disclosed techniques. The disclosed techniques may be parallelized. The graphics pipeline hardware may be used to efficiently implement depth buffering, stencils (e.g. for shadow volumes) and/or blending, which may not be efficient in technique based on a compute shader. Binning passes may be implemented by integrating existing binning techniques into the disclosed techniques.

Additionally, a decoupled texture shading process using a rendering pipeline according to this disclosure may be easy to integrate with application software. For example, an API may be modified, and/or an API extension may be created, to implement the pipeline functions and/or passes disclosed herein. These API modifications and/or extensions may be relatively minor and/or consistent with existing pipeline APIs, and may therefore be implemented as one or more incremental changes rather than a largely different software change that may be needed to use a compute shader to render textures. Thus, it may be relatively easy for software developers to port software to a system according to this disclosure.

FIG. 3 illustrates an embodiment of a texture coverage pipeline according to this disclosure. The pipeline 140 is illustrated in the context of a tile-based architecture, but the inventive principles may be applied to IMR and/or any other architectures. The embodiment illustrated in FIG. 3 may be used, for example, to implement some or all of the coverage texture computation and/or storage operations described above, and may be implemented as part of a rendering pipeline as described above.

The pipeline 140 may include a texture coverage shader 142, a texture unit 144, a pixel shader output buffer 146 which may be located, for example, in a rasterization unit 148, a color processing unit 150, and a tile buffer unit 152. In other embodiments, the pixel shader output buffer 146 may be separate from the rasterization unit 148. The texture coverage shader 142 may be implemented, for example, with a pixel shader configured to request texture coverage from the texture unit 144 by sending a coverage query or command to the texture unit 144. The texture unit 144, which may normally apply textures in response to data from a texture descriptor and sampler 146, may respond to the coverage query by returning coverage information rather than texture information to the pixel shader. In some embodiments, texture coverage may be calculated entirely by using pixel shader software. In some other embodiments, texture coverage may be calculated partially by using pixel shader software, for example, in a hybrid combination with one or more texture units that may be modified to compute texture coverage.

The texture coverage shader 142 may generate a texture coverage structure that specifies the texels and/or blocks of texels that may actually need to be accessed when the final image is rendered. In the embodiment illustrated in FIG. 3, coverage is shown using 5×2 blocks of texels 156, but the texture coverage data may be accumulated and/or stored at any level of granularity.

In some embodiments, some or all of the texture coverage data may be stored in a data buffer in color processing unit 150, which may be implemented, for example, with color blending hardware. In the embodiment illustrated in FIG. 3, the texture coverage data may pass through the pixel shader output buffer 146, but in other embodiments, the data be transferred directly to the color processing unit 150 or through other data paths.

In some embodiments, some or all of the texture coverage data may be stored in a tile buffer memory 154 in a tile buffer unit 152. The color processing unit 150 may transmit each coverage structure with one or more tile buffer addresses to locate the coverage blocks in the buffer.

In some embodiments, the texture coverage shader 142, texture unit 144, rasterization unit 148, color processing unit 150, and tile buffer unit 152 may each include logic 143, 145, 147, 151 and 153, respectively, configured to control the functions of each unit as described herein.

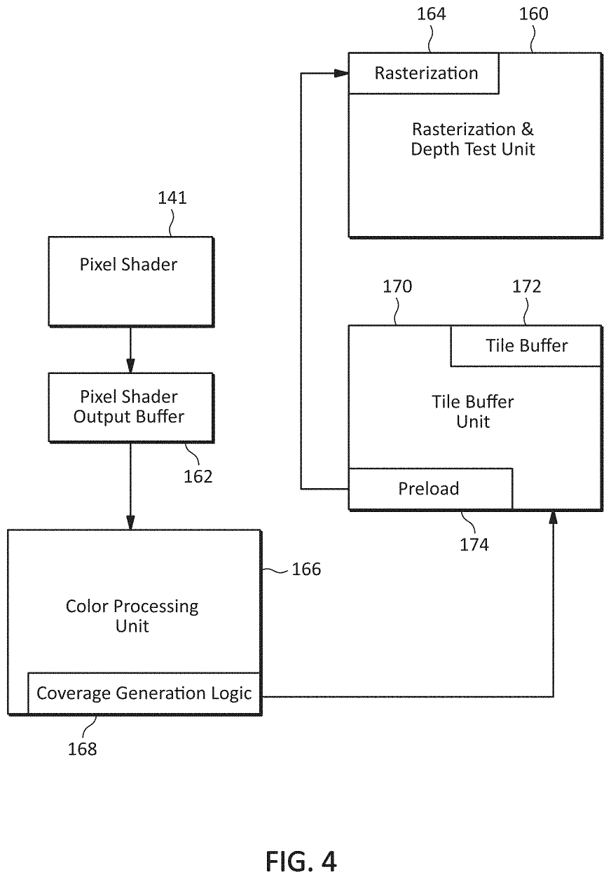

FIG. 4 illustrates embodiments of pipeline hardware components that may be used for a rendering pipeline that may support decoupled shading according to this disclosure. The embodiments illustrated in FIG. 4 may be used, for example, to implement some or all of the accumulation, storage and/or rendering operations described above, and may be implemented as part of a rendering pipeline as described above. In some embodiments, the components illustrated in FIG. 4 may be implemented by making relatively minor modifications to existing, proven hardware components in a rendering pipeline.

A pixel shader output buffer 162 may be configured to receive coverage information from a pixel shader 141 and supply the coverage information to a color processing unit 166. The color processing unit 166 may include coverage generation logic 168 that may be configured to transfer coverage structures to a tile buffer unit 170. For example, the logic 168 may extract block coverage data from rectangular regions of blocks, compute addresses and bitmasks in tile buffer words, and write accumulated data words to address locations in tile buffer 172. The tile buffer unit 170 may include preload logic 174 which may transfer texture coverage data to rasterization hardware 164 in a rasterization unit 160 (which may include depth (z) testing functionality) to enable the texture rendering pass to limit shading to covered texels. In some embodiments, the pixel shader output buffer 162 may be integral with the rasterization unit 160.

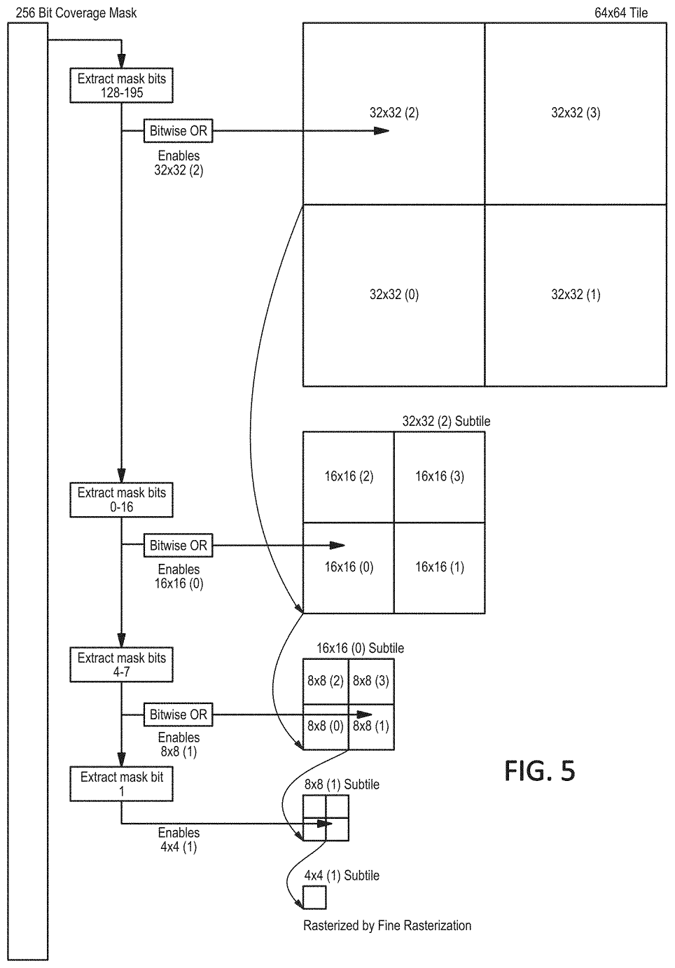

FIG. 5 illustrates an example embodiment of a bitmap rasterization decoding process for a texture culling operation according to this disclosure. The embodiment illustrated in FIG. 5 is described in the context of some specific implementation details such as mask and/or tile sizes, process steps, and/or the like, but these details are only for purposes of illustration, and the inventive principles are not limited to these details. For example, the rendered tile size is shown as 64×64 pixels (texels) and the block size is shown as 4×4 pixels. Thus, a 64×64 tile may contain 256 4×4 blocks, and 256 bits of mask may be used to mask off any subset of 4×4 blocks, but any other sizes may be used. In some embodiments, coverage extraction and testing may be implemented with simple multiplexer (MUX) and logic gates, which may provide fast decisions and/or use a small area.

The embodiment illustrated in FIG. 5 may be used, for example, to implement any of the texture render passes described above. For purposes of illustration, it is assumed to be used in the context of a tile-based system having a tile buffer unit, and rasterization and depth test unit. One data structure may be used for each rendered texture. Multiple rendered textures may use the same coverage data, however, if they use the same locations (u, v coordinates in texture space).

The tile buffer unit may read a segment of a texture coverage structure before opening a tile for rendering. The tile buffer unit may transfer the coverage data to the rasterization and depth test unit which may use it to cull coverage during coarse rasterization. When rendering a tile, the rasterization and depth test unit may apply this coverage data during a coarse hierarchical rasterization process to mask off coverage that may not be needed during image rendering.

Primitives may be rasterized in a hierarchical manner in which each level may be subdivided into four quadrants. At each hierarchical level, the quadrants may be tested to determine if there is, or may be, primitive coverage. If a quadrant has, or may have, primitive coverage, that quadrant may be subdivided further. The process may terminate when a certain fine rasterization level is reached. In this embodiment, this may be when 8×8 pixel quadrants are subdivided into 4×4 quadrants which have been tested for primitive coverage.

Although coarse rasterization may be illustrated in FIG. 5, in some implementations, an additional qualifier may be used to determine if a quadrant may be subdivided or sent to fine rasterization. Rasterization may begin at the 64 ×64 tile level. The coverage bit masks for each quadrant may be extracted and used to qualify further rasterizing in that quadrant. A coverage mask may contain 256, and one bit may map to each 4×4 tile. Full coverage qualification may include edge coverage and bounding box coverage. A quadrant may be subdivided, for example, if edge testing and/or bounding box test do not exclude the quadrant.

The specific example illustrated in FIG. 5 may proceed as follows. The 64 ×64 tile quadrants may be tested for coverage where each quadrant may use a 64 bit coverage mask. At the 64 ×64 rasterization, mask bits 128-195 may map to quadrant 2 (subtile 2) of the 64×64 tile which may be a quadrant of 32×32 pixels. In this example, at least one 4×4 in that block has a 1 bit in the coverage map, thereby invoking further rasterization of the quadrant which may be determined using a bitwise OR of the quadrant 4×4 coverage bits (bits 128-195). At the 32×32 stage of quadrant testing, only quadrant 0 has coverage, and therefore it proceeds to the 16×16 stage, where only quadrant 1 has coverage. At the 8×8 stage, quadrant 1 has coverage, and thus, fine rasterization may rasterize only this single 4×4 in this example. A quadrant may be considered to have coverage if at least 1 of its coverage bits is a logic 1, so the set of bits mapped to that quadrant is logically OR'ed. If more than one quadrant has coverage at any stage, the process may traverse down the quadrants in Z order. A given quadrant may be considered complete when all of its lower level rasterization hierarchy stages have been completed.

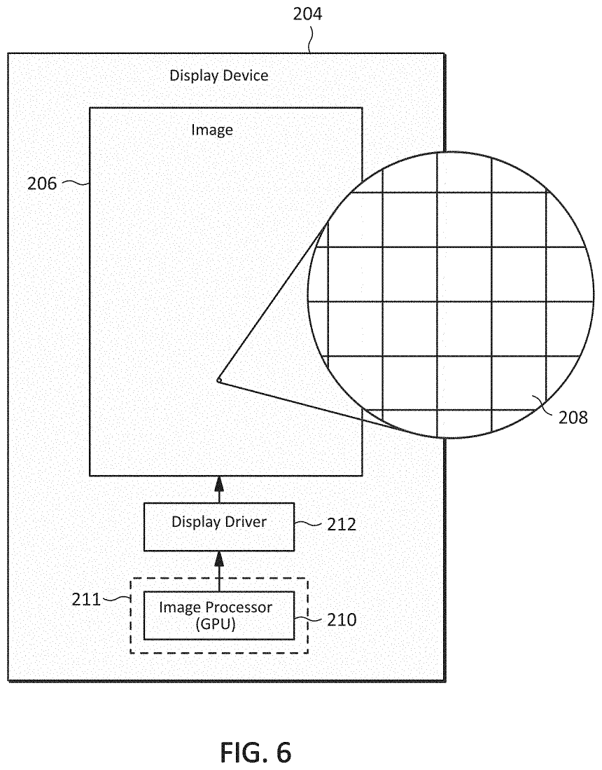

FIG. 6 illustrates an embodiment of an imaging device according to this disclosure. The imaging device 204 may have any form factor such as a panel display for a PC, laptop, mobile device, etc., a projector, VR goggles, etc., and may be based on any imaging technology such as cathode ray tube (CRT), digital light projector (DLP), light emitting diode (LED), liquid crystal display (LCD), organic LED (OLED), quantum dot, etc., for displaying a rasterized image 206 with pixels. An image processor 210 may be implemented with a graphics processing unit (GPU) which may implement any of the decoupled shading and/or texture rendering techniques according to this disclosure. A display driver circuit 212 may process and/or convert the image to a form that may be displayed on or through the imaging device 204. A portion of the image 206 is shown enlarged so pixels 208 are visible. Any of the methods or apparatus described in this disclosure may be implemented in the image processor 210 which may be fabricated on an integrated circuit 211. In some embodiments, the integrated circuit 211 may also include the display driver circuit 212 and/or any other components that may implement any other functionality of the display device 204.

The embodiments disclosed herein may be described in the context of various implementation details, but the principles of this disclosure are not limited these or any other specific details. Some functionality has been described as being implemented by certain components, but in other embodiments, the functionality may be distributed between different systems and components in different locations and having various user interfaces. Certain embodiments have been described as having specific processes, steps, combinations thereof, and/or the like, but these terms may also encompass embodiments in which a specific process, step, combinations thereof, and/or the like may be implemented with multiple processes, steps, combinations thereof, and/or the like, or in which multiple process, steps, combinations thereof, and/or the like may be integrated into a single process, step, combinations thereof, and/or the like. A reference to a component or element may refer to only a portion of the component or element. The use of terms such as “first” and “second” in this disclosure and the claims may only be for purposes of distinguishing the things they modify and may not indicate any spatial or temporal order unless apparent otherwise from context. A reference to a first thing may not imply the existence of a second thing. The characterization of an element in an embodiment as being “optional” does not imply that any other element in the embodiment is mandatory. In any of the embodiments disclosed herein, any of the elements may be omitted without departing from the principles of this disclosure. Moreover, the various details and embodiments described above may be combined to produce additional embodiments according to the inventive principles of this patent disclosure. Specialized hardware may include general purpose hardware configured for specialized functions such as a field programmable gate array (FPGA), complex programmable logic device (CPLD), and/or the like.

Since the inventive principles of this patent disclosure may be modified in arrangement and detail without departing from the inventive concepts, such changes and modifications are considered to fall within the scope of the following claims.

1. A method for rendering an image in a graphics processing system, the method comprising:
calculating texture coverage data for at least a portion of an image during an image coverage pass using a rendering pipeline;
generating rendered texture data during a texture rendering pass in texture space based on the texture coverage data using one or more hardware resources of the rendering pipeline; and
rendering the image based on the rendered texture data using the rendering pipeline.

2. The method of claim 1, wherein at least a portion of the texture coverage data is calculated by a texture unit in response to a query.

3. The method of claim 1, further comprising storing at least a portion of the texture coverage data in a hardware resource of the rendering pipeline.

4. The method of claim 1, further comprising storing at least a portion of the texture coverage data in a hierarchical data structure.

5. The method of claim 1, further comprising storing at least a portion of the texture coverage data in a compressed data structure.

6. The method of claim 3, wherein the texture coverage data is stored in a color processing unit.

7. The method of claim 3, wherein the texture coverage data is stored in a tile buffer.

8. The method of claim 3, wherein the texture coverage data is stored in a cache.

9. The method of claim 3, wherein the texture coverage data is stored in a multiple render target (MRT).

10. The method of claim 9, wherein the texture coverage data stored in the MRT comprises multiple coverages.

11. The method of claim 1, wherein the texture coverage data is calculated for two or more textures.

12. The method of claim 11, wherein the two or more textures are independently addressed.

13. The method of claim 11, wherein at least a portion of the texture coverage data comprises common location data for the two or more textures.

14. The method of claim 1, wherein the texture coverage data is used to limit surviving rasterization coverage during the texture rendering pass.

15. A graphics processing system comprising:
a rendering pipeline configured to support decoupled shading, the pipeline comprising:
a data buffer configured to receive texture coverage data for an image; and
a rasterization unit configured to read the texture coverage data from the data buffer and use the texture coverage data to limit rasterization coverage during a texture rendering pass for the image.

16. The system of claim 15, wherein the rasterization unit is configured to use two or more sets of texture coverage data.

17. The system of claim 16, wherein the rasterization unit is configured to use the two or more sets of texture coverage data to limit coverage to adding additional coverage for a later frame.

18. The system of claim 16, wherein the rasterization unit is one of two or more rasterization units arranged such that rendering is partitioned among the two or more rasterization units.

19. The system of claim 15, wherein the data buffer is at least partially contained in a color processing unit.

20. The system of claim 15, wherein the data buffer is at least partially contained in one or more of a tile buffer unit or a cache.

21. The system of claim 15, wherein the rendering pipeline is configured for tile-based rendering.

22. A graphics processing system comprising:
a rendering pipeline configured to support decoupled shading, the pipeline comprising:
a texture unit configured to receive a coverage query from a shader during an image coverage pass, compute texture coverage data for an image in response to the coverage query, and return the texture coverage data to the shader.

23. The system of claim 22, wherein the shader comprises a pixel shader.
